(19) United States
(12) Patent Application Publication
(10) Pub. No.: US 2007/0026184 A1
(43) Pub. Date: Feb. 1, 2007

(54) Label, web of material and method of the production thereof

(76) Inventors: Tanja Ehreiser, Neufahrn (DE); Thomas Koberlein, Munich (DE); Uwe Birk, Munich (DE)

Correspondence Address: WILLIAM COLLARD;COLLARD & ROE, P.C., 1077 NORTHERN BOULEVARD, ROSLYN, NY, 11576, US

(21) Appl. No.: 10/571,356

(22) PCT Filed: Sep. 3, 2004
(86) PCT No.: PCT/EP04/09855

§ 371 Date: May 24, 2006

(30) Foreign Application Priority Data
Sep. 10, 2003 (DE) 103 41 807.5

(51) Int. Cl. G09F 3/00

(52) U.S. Cl. 428/43

(57) ABSTRACT

The invention relates to a label, which when used, is stuck to a specific object in a simple manner with the air of an adhesive layer. However, it is not possible to remove the label without causing damage since some of the weakness lines become torn as a result of the tension prevailing in the layers of film during removal thereof. Since the two film layers are segmented, it is of no importance whether the upper film layer or the lower film layer is touched during manipulation. According to the invention, layers of film having pre-cut weakness lines are stamped out of a web of material and areas which are separated from the rest of the film layer of the label by means of a weakness line can be created in the individual layer of film, ensuring that the label is not damaged when it is applied to a specific object, or when it is repositioned. The necessary cohesion is created by the fact that the weakness lines of one film layer do not coincide with weakness lines in another respective film layer.

The present invention relates to a material web for manufacturing labels, a label manufactured therefrom, and a method for their manufacture.

Many applications of stick-on labels require precautions which prevent the label from being removed from the object to which it was originally attached and being misused by being stuck on another object. This applies in particular for labels which function as nontransferable stamps, such as highway toll stickers, or which confirm the authenticity of the document or other object to which they are attached. This is also true for labels which serve as evidence of existing certificates of the object provided therewith (e.g., vehicle inspection cards), as well as for price labels in stores, which should not be able to be removed from a cheaper article and stuck on a more expensive article unnoticed.

In order to make misuse of this type more difficult, until now the label material has frequently been implemented as so weak and the adhesive bond to the substrate has been implemented as so strong that the label tears when the attempt is made to remove it undamaged from the substrate. A disadvantage of this measure is that the label may also be removed from the substrate only with difficulty when a residue-free removal is actually desired, for example, when the validity period of a highway toll sticker has expired. Furthermore, the required films, which are mechanically less stable, are usually more expensive than label material more resistant to tearing.

A further known measure for making the undamaged removal of labels more difficult is to provide weakening lines in the labels. Weakening lines are also to be understood in the following and above all as interruption lines, i.e., lines along whose course a film or film layer is cut through its entire thickness weakening lines may be implemented as stamps or punches, cuts, perforations, grooves, or the like. In the stuck-on state, the weakening lines prevent the entire label from being pulled off, since it tears into individual parts along the weakening lines and/or originating therefrom. Reassembling the individual parts is impossible or is only possible with great effort.

If the weakening lines run continuously from edge to edge within a label, the problem arises that dispensing the label is difficult, since the partial areas of the label formed by the weakening lines are held together only weakly—for example, by the adhesive layer of the label, which is not weakened—between the removal from the label carrier web and the sticking onto the intended object. Labels of this type represent the typical standard in price labeling in supermarkets.

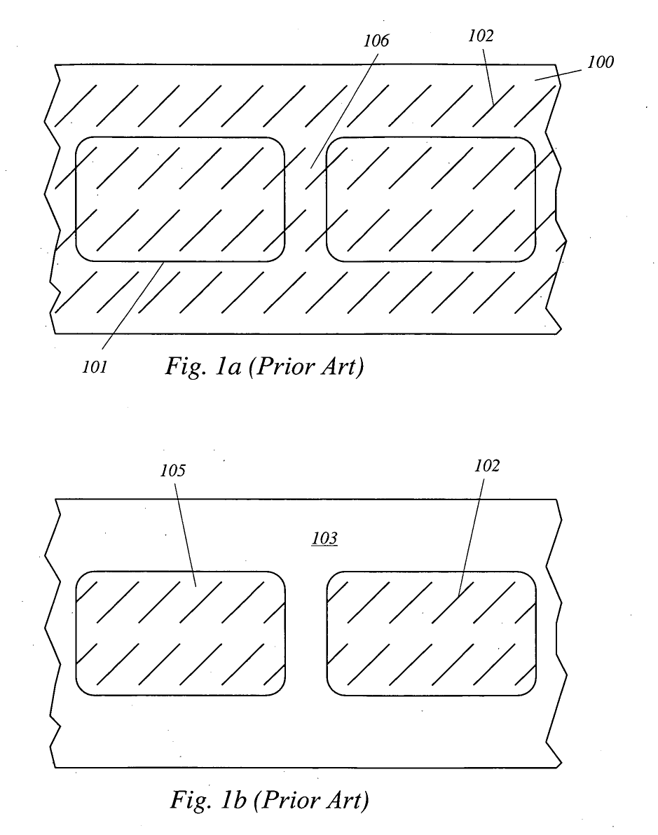

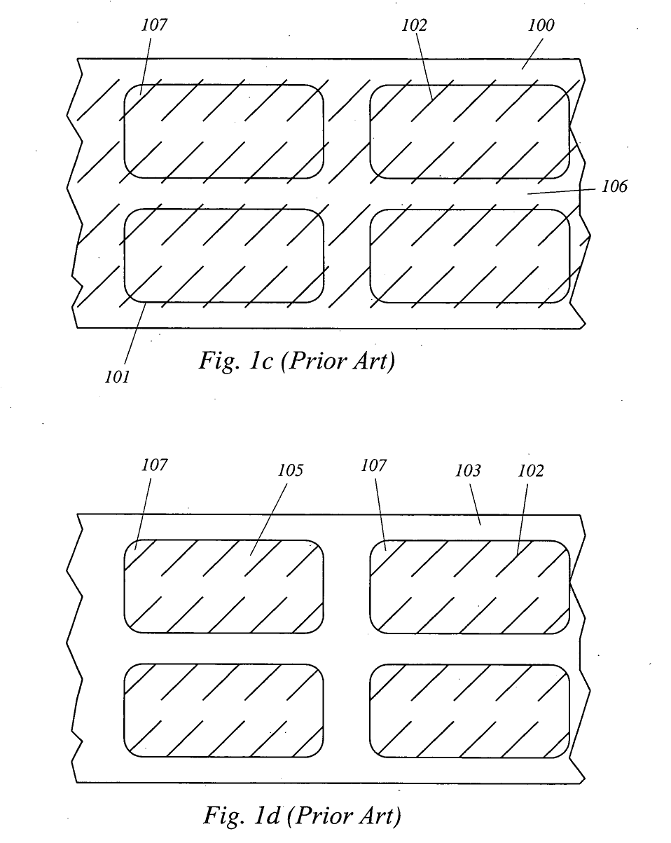

In order to increase the stability of the label during dispensing, the weakening lines may also be interrupted by ribs, through which the film area remains coherent. However, the is typically function only for selected geometries of labels and arrangements of the weakening lines, because labels are typically stamped out of coherent material webs which have been provided with weakening lines before the stamping procedure. In the event of unfavorable stamp position of the labels in relation to the weakening lines, large areas at the corners of the label, for example, may be divided from the remainder of the label by a weakening line. The problems worsen with decreasing label size and are explained once again in the following for the related art on the basis of FIGS. 1a through 1d.

The material web 100 according to the related art illustrated in a top view in FIG. 1a is coated with a pressure-sensitive adhesive, provided with weakening lines 102, and positioned on a carrier web 103 (covered in FIG. 1a) made of pull-off material. The stamping lines 101, which are closed per se, provide the labels 105 illustrated in FIG. 1b after removal of the lattice 106, which are provided with pressure-sensitive adhesive on the carrier web 103. Each of the labels may now be applied coherently to the intended object and will tear originating from the weakening lines 102 upon the attempt to remove the label again.

If the position of the stamping lines 101 defining the labels 105 is less favorable during stamping out of the material web 100, as shown in FIG. 1c, labels 105 which have partial areas 107 separated from the remaining label by weakening lines 102 result after the lattice 106 is pulled off, as shown in FIG. 1d. A label 105 of this type may lose the separate partial areas 107 already upon removal from the carrier web 103 if the bottom pressure-sensitive adhesive layer (not shown) does not itself hold the label 105 together. It hardly needs to be mentioned that the tear strength and/or internal cohesion of a pressure-sensitive adhesive layer is relatively slight, so that this coherence is hardly sufficient.

The unfavorable position of the stamping lines 101 defining the labels 105 may therefore originate because labels 105 of different sizes and shapes are stamped or cut out as required from one and the same material web 100.

The ability to reposition the label is often required by the user. This is understood as the possibility of removing the label stuck on an object within a certain time span after the application and repositioning it, in order to correct a faulty position or orientation, for example. Only after this time span is a label of this type to achieve the property of no longer being removable undamaged. This is generally achieved by the use of adhesives whose full adhesive force only result after a certain time. However, if a label has separate partial areas 107, as shown in FIG. 1d, repositioning without destroying the label 105 is inconceivable even shortly after the application, since for typical adhesives the adhesion is more strongly pronounced than the internal cohesion.

According to another label construction known from DE 299 13 746 U1, in addition to a layer provided with weakening lines and a pressure-sensitive adhesive layer for attachment to a substrate, a continuous upper film is also provided, which is attached to the layer provided with weakening lines using adhesive. The upper film holds the label parts together and ensures the ability to reposition the label. Furthermore, a smooth surface which may thus be printed at high resolution results in this way. However, when a construction of this type is implemented using cost-effective, relatively mechanically stable films, the problem again results that the printed upper film may be pulled off and stuck onto another object. The manipulation protection originally sought through the weakening lines is therefore no longer completely ensured.

The present invention is based on the object of providing a material web for manufacturing manipulation-safe labels and/or a manipulation-safe label which may be manufactured therefrom, in which the problems described of a label construction according to the typical pattern do not occur. In particular, it is to be ensured that the material web allows arbitrarily shaped labels to be cut or stamped out without impairing manipulation security. In this case, a good ability to reposition as defined above is sought.

Furthermore, it is the object of the present invention to provide a method for manufacturing manipulation-safe labels.

According to one aspect of the present invention, this object is achieved by a material web according to Claim 1. Advantageous embodiments of the material web may be designed according to one of Claims 2 through 16.

According to a further aspect of the present invention, the object is achieved by a label according to Claim 17 which may be manufactured through stamping or cutting out from a material web according to the present invention, cutting out also being able to be understood as cutting off a label at the leading end of the material web. Advantageous embodiments of the label may be designed according to one of Claims 18 through 32.

Weakening lines in the different film layers which are offset and/or at an angle to one another ensure that even if a film layer is completely separated from the remainder of the same film layer of the label after the stamping of a label, the separate part is still connected to the remaining label via another film layer. By using a suitable adhesive which only achieves its full adhesive force after a certain time span, an ability to reposition which is initially good may be achieved without the manipulation protection reached through the weakening lines being impaired after this time span has passed.

In principle, weakening lines according to the present invention may be implemented as stamps or punches, cuts, perforations, grooves, or the like. Preferably, they are implemented as interruption lines, i.e., as lines along whose course the corresponding film layer is cut through its entire thickness. Film layers as defined in the present invention are primarily understood as plastic films, but also metal and metal composite films, thin paper or fabric layers, and the like. A weakening line having a free end is to be understood to mean that the weakening line is not closed per se, i.e., does not enclose a continuous area.

According to a further aspect of the present invention, the object is achieved by a method according to Claim 33. Advantageous embodiments of the method may be implemented according to one of Claims 34 through 36.

In the following, exemplary embodiments according to the present invention are explained in greater detail on the basis of the associated figures, which are purely schematic. The figures are not to scale, in particular layer thicknesses are greatly exaggerated for reasons of clarity.

FIGS. 1a-d show material webs having stamped out labels according to the related art, before and after removal of the lattice, as explained above.

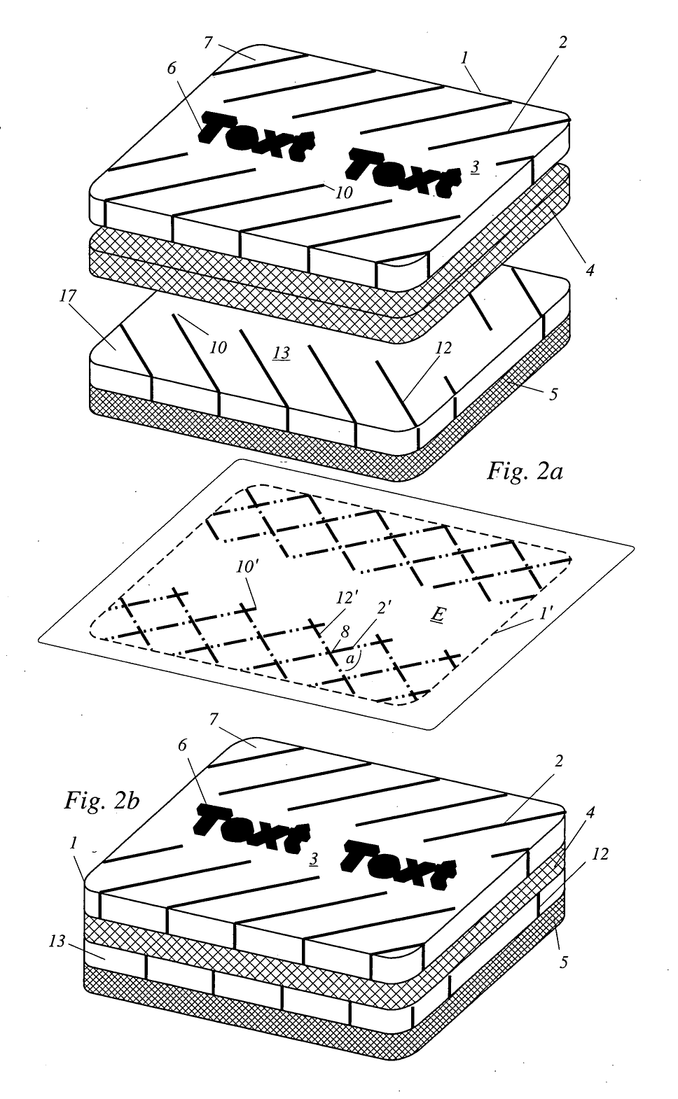

FIG. 2a shows a perspective view of a label according to the present invention having an imprint, the individual layers being shown partially separated from one another like an exploded drawing for reasons of clarity and an imaginary plane of protection being drawn in.

FIG. 2b shows the label from FIG. 2a, but with a coherent illustration of the layers of the label.

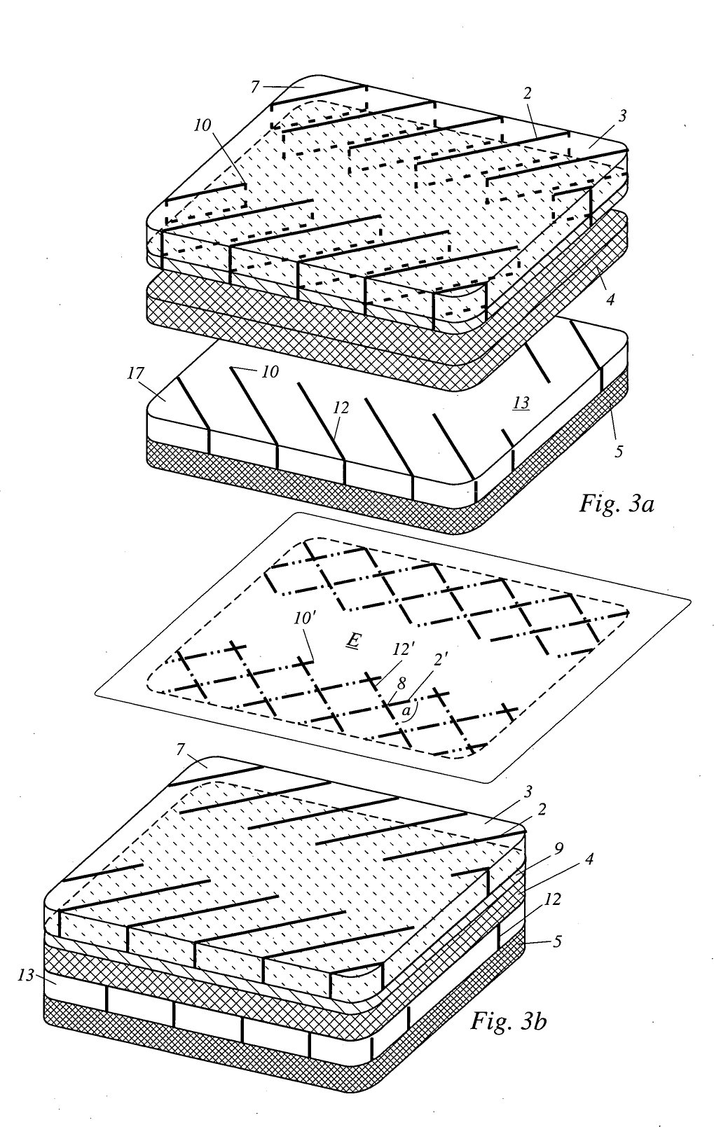

FIG. 3a shows a perspective view of a laser-writable label according to the present invention, the individual layers being shown partially separated from one another like an exploded drawing for reasons of clarity and an imaginary plane of projection being drawn in.

FIG. 3b shows the label from FIG. 3a, but with a coherent illustration of the layers of the label.

The label illustrated in FIG. 2a and FIG. 2b is manufactured according to the method according to the present invention by stamping from a material web according to the present invention, and therefore displays basically the same layer construction as the latter. To visualize a material web according to the present invention, one only has to conceive the illustrated label layers 3, 13, 4, 5 continued in the plane of their largest dimensions beyond the stamped label edge 1, whose course is illustrated as a closed dashed line 1′ in the plane of projection E.

Both the upper film layer 3 and also the lower film layer 13 each have multiple weakening lines 2, 12, which are stamped through the particular film layer 3, 13. The film layers 3, 13 are glued to one another via the adhesive layer 4. In the manufacturing process of the material web from which the label is stamped, a construction of this type is produced by providing each of the film layers 3 and 13 with the weakening lines 2, 12 separately from one another by stamping and subsequently gluing them to one another.

On its bottom side, the label has a pressure-sensitive adhesive layer 5, using which it is positioned on a web made of pull-off material (not shown) before its intended use together with similar labels which have been stamped out of the same material web. In application, the label is simply stuck onto an intended object (not shown), such as a document, a car window, or a license plate, with the aid of the pressure-sensitive adhesive layer 5. It may not be removed therefrom without destruction, since corresponding attempts fail because at least some of the weakening lines 2, 12 tear further because of the tensions existing in the film layers 3, 13 during the removal attempt. Since both film layers 3, 13 are segmented, it is unimportant in a manipulation attempt whether the upper or lower film layer 3, 13 is grasped. The manipulation security is increased if the adhesive force of the pressure-sensitive adhesive layer 5 on the substrate, i.e., the surface of the intended object, is greater than that of the adhesive force of the adhesive layer 4 holding together the film layers 3, 13.

If the pressure-sensitive adhesive layer 5 comprises a pressure-sensitive adhesive which allows the ability to reposition as defined above, destruction-free removal is obviously briefly still possible after being stuck on.

In principle, the adhesive layers 4 and 5 may also comprise solvent glue, multicomponent adhesive, and other adhesive materials instead of the pressure-sensitive adhesive which is preferably used. The contact area during welding of the film layers 3, 13 to one another is also implemented as an adhesive layer 4 according to the present invention.

Even if areas 7, 17 which are separated from the particular remaining film layer 3, 13 of the label via a weakening line 2, 12 during the manufacturing (through stamping out from a material web having film layers 3, 13 containing pre-stamped weakening lines 2, 12) may arise, it is still ensured that the label does not fall apart when it is dispensed on the intended object, or when it must be repositioned. The required adhesion results because the course of the weakening lines 2, 12 of a film layer 3, 13 is not congruent with the weakening lines 2, 12 in the particular other film layer 3, 13: since the separate areas 7, 17 are connected via the adhesive layer 4 to the particular other film layer 3, 13, these areas 7, 17 are largely prevented from detaching unintentionally from the label.

The functions of the film layers 3, 13 supplement one another especially well if the course 2′ of the weakening lines 2 of the upper film 3 projected in the plane of projection E oriented parallel to the film layers 3, 13 intersects with the course 12′ of the weakening lines 12 in the lower film layer 13 projected in the plane of projection E. The courses 2′, 12′ in the plane of projection E are indicated by double dot-dash lines.

It is especially advantageous if the smaller angle a enclosed at the intersection point 8 between the projected courses 2′, 12′ measures more than 30°, preferably more than 60°, ideally nearly 90°.

In principle, it is advantageous for the weakening lines 2, 12 if they are not closed per se, but rather have free ends 10 (reference numbers 10′ in the projection), from which the corresponding film layer 3, 13 tears further in case of a manipulation attempt.

Of course, it is also possible to arrange the weakening lines 2, 12 in other patterns, such as serpentine lines, circular sectors, herringbone patterns, etc. The upper film layer 3 is provided with an inscription 6. This may be manufactured using an arbitrary common reproduction, printing, or marking technology.

Since a preferred area of application of the label according to the present invention is the use as a stamp, certificate of authenticity, or the like, the label may also have additional security features which make it largely forgery-proof. For example, imprints in fluorescent inks or similar things are conceivable. Furthermore, the upper film layer 3 may comprise a hologram film, or the lower film layer 13 may comprise a hologram film, which advisably also requires at least partial transparency of the upper film layer 3 and the adhesive layer 4. In principle, each of the film layers 3, 13 may be implemented as transparent, partially transparent, or opaque as needed.

The label illustrated in FIG. 3a and FIG. 3b differs from the label illustrated in FIG. 2a and FIG. 2b only through the design of the upper film layer 3. Adhesive layer 4, lower film layer 13, and pressure-sensitive adhesive label 5 are implemented as in FIGS. 2a, 2b, because of which the same reference numbers are also used. The arrangement of the weakening lines 2, 12 is also as in FIGS. 2a, 2b, which is also obvious on the basis of their projection lines 2′, 12′ in the plane of projection E.

The upper film layer 3 predominantly comprises transparent plastic which is provided on the bottom with a metal coating 9. This is typically implemented as silver-white or black and is generated through sputtering or vapor deposition in vacuum. Using a laser beam, the metal coating 9 may be ablated locally, so that the contours of characters or graphic symbols result, which are recognizable through the transparent plastic of the upper film layer 3.

Preferably, either the adhesive layer 4 or the lower film layer 13 is colored in a contrast ink which stands out well from the color of the metal coating.

Alternatively, the lower film layer 13 may also be provided on the top or bottom with a metal coating which may be laser ablated. In the latter case, the plastic component of the film layer 13 (and also the upper film layer 3) must be transparent to the laser, of course, in the first case it may be solidly colored and serve as a contrast layer to the non-ablated remainder of the metal coating.

An inscription may also be produced using other common methods, such as through direct laser marking or another layer-addressing method. For example, a laser inscription may also be achieved by implementing the upper film layer 3 as transparent and not metal coated, and the inscription may result through local burning off of the colored adhesive layer 4.

1. A material web for manufacturing labels, having at least two film layers (3, 13), which are bonded to one another via an adhesive layer (4), wherein at least two of the film layers (3, 13) have weakening lines (2, 12) and the course (2′, 12′) of the weakening lines (2, 12) of one film layer (3, 13) deviates in projection from the course (2′, 12′) of the weakening lines (2, 12) of another film layer (3, 13) when a plane of projection (E) parallel to the film layers (3, 13) is assumed.

2. The material web according to claim 1, wherein all film layers (3, 13) have weakening lines (2, 12) and the course (2′, 12′) of the weakening lines (2, 12) of one film layer (3, 13) deviates in projection from the course (2′, 12′) of the weakening lines (2, 12) of a neighboring film layer (3, 13) when a plane of projection (E)parallel to the film layers (3, 13) is assumed.

3. The material web according to claim 1, wherein at least two weakening lines (2, 12), which have free ends (10), are provided in each of at least two of the film layers (3,13).

4. The material web according to claim 1, wherein the weakening lines (2, 12) of a film layer (3, 13) form a periodically repeating pattern.

5. The material web according to claim 1, wherein the course (2′, 12′) of the weakening lines (2, 12) of one film layer (3, 13) intersects in projection with the course (2′,12′) of at least one weakening line (2, 12) of another film layer (3, 13) when a plane of projection (E) parallel to the film layers (3, 13) is assumed.

6. The material web according to claim 5, wherein the course (2′,12′) of the majority of the weakening lines (2, 12) of the film layer (3, 13) intersects in projection with the course (2′, 12′) of at least one weakening line (2, 12) of another film layer (3, 13) when a plane of projection (E) parallel to the film layers (3, 13) is assumed.

7. The material web according to claim 5, at a point (8) in the plane of projection (E) at which two weakening lines (2, 12) of different film layers (3, 13) intersect, the smaller of the two angles of intersection (a) is at least 30°.

8. The material web according to claim 7, wherein, at the majority of the points (8) in the plane of projection (E) at each of which two weakening lines (2, 12) of different film layers (3, 13) intersect, the smaller of the two angles of intersection (a) is at least 30°.

9. The material web according to claim 5, wherein, at a point (8) in the plane of projection (E) at which two weakening lines (2, 12) of different film layers (3, 13) intersect, the smaller of the two angles of intersection (a) is at least 60°.

10. The material web according to claim 9, wherein, at the majority of the points (8) in the plane of projection (E) at each of which two weakening lines (2, 12) of different film layers (3,13) intersect, the smaller of the two angles of intersection (a) is at least 60°.

11. The material web according to claim 1, wherein the material web has a self-adhesive layer (5) its bottom side.

12. The material web according to claim 11, which is positioned on a carrier web made of pull-off material via the self-adhesive layer (5).

13. The material web according to claim 11, wherein the adhesive strength per unit area between the film layers (3, 13) bonded via the adhesive layer (4) is less than the adhesive strength per unit area of the self-adhesive layer (5) on a substrate intended for the label.

14. The material web according to claim 13, wherein the substrate is at least one of a group consisting of paper, glass, metal, plastic, and lacquer.

15. The material web according to claim 1, wherein the material web has an inscription (6) in the form of at least one of a group consisting of alphanumeric characters, symbols, and graphics.

16. The material web according to claim 15, wherein the inscription is a laser inscription.

17. A label, having at least two film layers (3, 13), which are bonded to one another via an adhesive layer (4), wherein at least two of the film layers (3, 13) have weakening lines (2, 12), and the course (2′, 12′) of the weakening lines (2, 12) of one film layer (3, 13) deviates in projection from the course (2′, 12′) of the weakening lines (2, 12) of another film layer (3, 13) when a plane of projection (E) parallel to the film layers (3, 13) is assumed.

18. The label according to claim 17, wherein all film layers (3,13) have weakening lines (2, 12), and the course (2′, 12′) of the weakening lines (2, 12) of one film layer (3, 13) deviates in projection from the course (2′, 12′) of the weakening lines (2, 12) of a neighboring film layer (3, 13) when a plane of projection (E) parallel to the film layers (3, 13) is assumed.

19. The label according to claim 17, wherein at least two weakening lines (2, 12), which have free ends (10), are provided in each of at least two of the film layers (3, 13).

20. The label according to claim 17, wherein the weakening lines (2, 12) of the film layer (3, 13) form a periodically repeating pattern.

21. The label according to claim 17, wherein the course (2′, 12′) of the weakening lines (2, 12) of one film layer (3, 13) intersects in projection with the course (2′, 12′) of at least one weakening line (2, 12) of another film layer (3, 13) when a plane of projection (E) parallel to the film layers (3, 13) is assumed.

22. The label according to claim 21, wherein the course (2′, 12′) of the majority of the weakening lines (2, 12) of the film layer (3, 13) intersects in projection with the course (2′, 12′) of at least one weakening line (2, 12) of another film layer (3, 13) when a plane of projection (E) parallel to the film layers (3, 13) is assumed.

23. The label according to claim 21, wherein, at a point (8) in the plane of projection (E) at which two weakening lines (2, 12) of different film layers (3, 13) intersect, the smaller of the two angles of intersection (a) is at least 30°.

24. The label according to claim 23, wherein, at the majority of the points (8) in the plane of projection (E) at each of which two weakening lines (2, 12) of different film layers (3, 13) intersect, the smaller of the two angles of intersection (a) is at least 30°.

25. The label according to claim 21, wherein, at a point (8) in the plane of projection (E) at which two weakening lines (2, 12) of different film layers (3, 13) intersect, the smaller of the two angles of intersection (a) is at least 60°.

26. The label according to claim 25, wherein, at the majority of the points (8) in the plane of projection (E) at each of which two weakening lines (2, 12) of different film layers (3, 13) intersect, the smaller of the two angles of intersection (a) is at least 60°.

27. The label according to claim 17, wherein the label has a self-adhesive layer (5) on its bottom side.

28. The label according to claim 27, which is positioned via the self-adhesive layer (5) on a carrier web made of pull-off material.

29. The label according to claim 27, which is positioned on a

32. The label according to claim 31, wherein the inscription is a laser inscription.

33. A method for manufacturing labels, wherein the labels are cut or stamped out of a material web having at least two film layers (3, 13), which are bonded to one another via an adhesive layer (4), wherein at least two of the film layers (3, 13) have weakening lines (2, 12) of one film layer (3, 13) deviates in projection from the course (2′, 12′) of the weakening lines (2, 12) of another film layer (3, 13) when a plane of projection (E) parallel to the film layers (3, 13) is assumed.

34. The method according to claim 33, wherein the contours of the labels are stamped out of the material web positioned on a web made of pull-off material, so that after a lattice arising between the label contours is pulled off, a sequence of the labels adhering to the web made of pull-off material results.

35. The method according to claim 33, wherein the contours of the labels are cut out of the material web using a laser and a laser inscription of the material web is performed. the weakening lines (2, 12) of another film layer (3, 13) when a plane of projection (E) parallel to the film layers (3, 13) is assumed.

34. The method according to claim 33, wherein the contours of the labels are stamped out of the material web positioned on a web made of pull-off material, so that after tho a lattice arising between the label contours is pulled off, a sequence of the labels adhering to the web made of pull-off material results.

35. The method according to claim 33, wherein the contours of the labels are cut out of the material web using a laser and a laser inscription of the material web is performed.

36. The method according to claim 33, wherein the labels are cut starting from a particular edge of the material web.

37. The method according to claim 33, wherein the contours of the labels are cut out of the material web using a laser and a laser inscription of the labels is performed.

38. The label according to claim 27, which is positioned via the self-adhesive layer (5) on a sheet made of pull-off material.
